(19) United States
(12) Patent Application Publication
(10) Pub. No.: US 2022/0375439 A1
(43) Pub. Date: Nov. 24, 2022

(54) INTEGRATED DRUMSTICK AND KEY

(71) Applicant: Jared N. Rodabough, Sandy, UT (US)

(72) Inventor: Jared N. Rodabough, Sandy, UT (US)

(21) Appl. No.: 17/663,946

(22) Filed: May 18, 2022

Related U.S. Application Data
(60) Provisional application No. 63/190,124, filed on May 18, 2021.

(51) Int. Cl. G10D 13/12; G10D 13/10

(52) U.S. Cl. CPC G10D 13/12; G10D 13/25

(57) ABSTRACT

A drumstick is integrated with a drum key for ready availability of a drum key in more situations. The drumstick provides an elongated handle for actuating the key while the key's presence does not interfere with the drumstick's natural use. The drumstick may be organically fashioned with a drum key hollowed out from its own material, thereby providing the requisite negative space, or an insert may be positioned within a butt end of the drumstick which presents the negative space of the drum key. Alternately a sleeve may be positioned on the drumstick to accommodate a key insert or an integral key portion.

### CROSS-REFERENCES TO RELATED APPLICATIONS

This application claims priority as a non-provisional perfection of prior U.S. Application No. 63/190,124, filed May 18, 2021, and incorporates the same by reference herein in its entirety.

### FIELD OF THE INVENTION

The present invention relates to the field of musical instruments and more particularly relates to a drumstick with and integrated drum key.

### BACKGROUND OF THE INVENTION

The modern drum is the descendent of one of the oldest instruments in human history and its concept has not departed far from its ancestor. Early drums, or membranophones, consisted of a skin or other membrane stretched over a supporting hollow shell and then beat either by hand, stick, or other structure to produce sound. The modern drum does not depart far from this concept, but it structures have advanced considerably. A typical modern drum consists of one or two drumheads positioned over a shell and held in position by a counter hoop. The shell features a plurality of circumferential lugs about its exterior into which tension rods are threadingly engaged. These tension rods pull the counter hoops into a closer relationship with the shell and heads, thereby tightening the heads and adjusting the tonal output of the drum. The tension rods typically feature a square head which requires a special drum key to tighten or loosen the tension rods and the associated heads.

A typical drum key features a center post with some form of lateral crossbar. The tip of the center post of the drum key is hollowed and fashioned into a square so that it may interface with the square head of the tension rods. Unfortunately, drum keys tend to be easily lost and are not very conveniently stored in a manner that allows their easy access and use during emergencies. For many individuals, their small size also inhibits efficient use. What is needed then is an improved drum key interface which is conveniently located on or about the person of a drummer while providing an easier used adjustment tool.

The present invention is a drumstick with an integral drum key. The present invention represents a departure from the prior art in that the drum key of the present invention is in the butt of a drumstick and, therefore, is always on the person of the drummer. The location of the drum key does not interfere with the use of the drumstick while the axial relationship between the key orifice and the drumstick allows the entire drumstick to be used as a handle for the key without a crosswise element. The larger surface area of the drumstick provides a large tool interface which is particularly helpful for those with larger hands.

### SUMMARY OF THE INVENTION

In view of the foregoing disadvantages inherent in the known types of drum keys, an improved drum key may provide an integrated drumstick and key that meets the following objectives: that it is easy to produce, that it is intuitive to operate, that its construction will not interfere with operation either as a drumstick or as a drum key, and that it will provide a larger surface area easier use as a drum key. As such, a new and improved integrated drumstick and key may comprise a drumstick body with a key orifice designed to interface with drum tension rods located at its base to accomplish these objectives.

The more notable features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in many ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions as far as they do not depart from the spirit and scope of the present invention.

### BRIEF DESCRIPTION OF THE DRAWINGS

To describe the way the above-recited and other advantages and features of the invention can be obtained, a more particular description of the invention briefly described above will be rendered by reference to specific example embodiments thereof which are illustrated in the appended drawings. Understanding that these drawings depict only typical embodiments of the invention and are therefore not to be considered as limiting of its scope, the invention will be described and explained with additional specificity and detail using the accompanying drawings.

FIG. 1 is an elevational view of a drumstick according to one embodiment of the invention.

FIG. 2 is a sectional view of the drumstick of FIG. 1, taken along line II-II.

FIG. 3 is a sectional view of the drumstick of FIG. 2, taken along line III-Ill.

FIG. 4 is a sectional view of the drumstick of FIG. 2, taken along line IV-IV.

FIG. 5 is a sectional view of a drumstick according to an alternate drumstick, taken along the same view as FIG. 3.

FIG. 6 is a sectional view of a drumstick according to an alternate drumstick, taken along the same view as FIG. 4.

FIG. 7 is an exploded view of a third alternate embodiment drumstick.

FIG. 8 is an elevational view of the drumstick of FIG. 8, assembled.

FIG. 9 is an elevational view of a fourth alternate drumstick.

### DETAILED DESCRIPTION OF THE PREFERRED EMBODIMENT

With reference now to the drawings, a preferred embodiment of the integrated drumstick and key is herein described. It should be noted that the articles “a,” “an,” and “the,” as used in this specification, include plural referents unless the content clearly dictates otherwise.

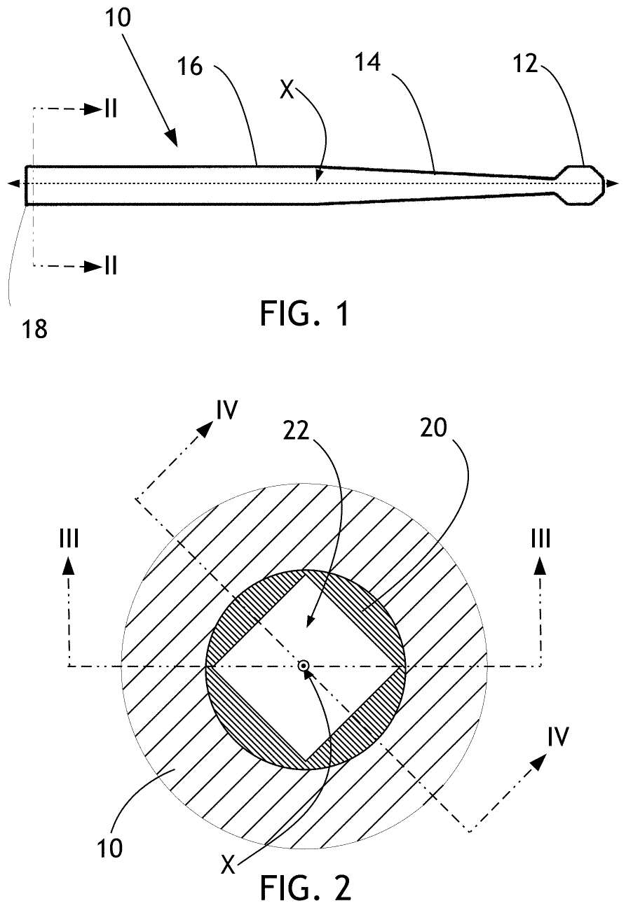

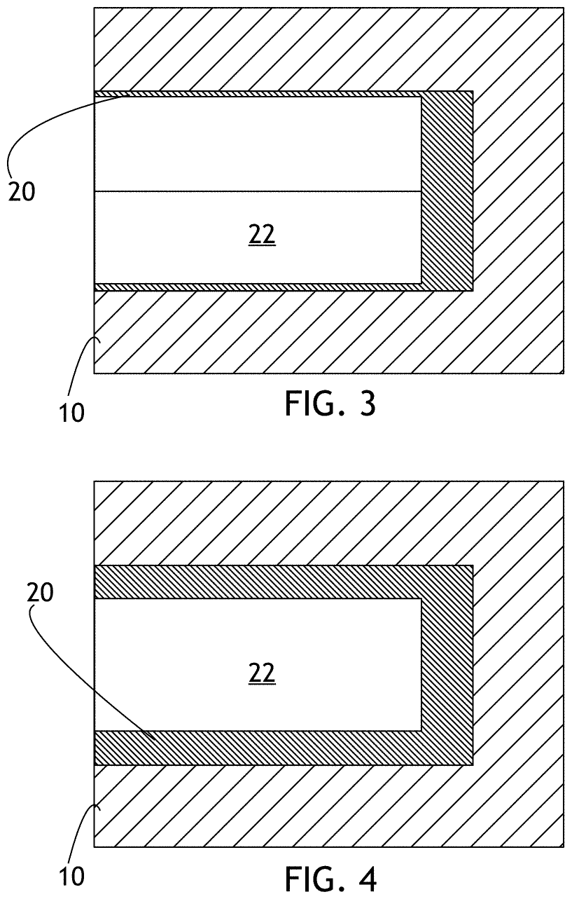

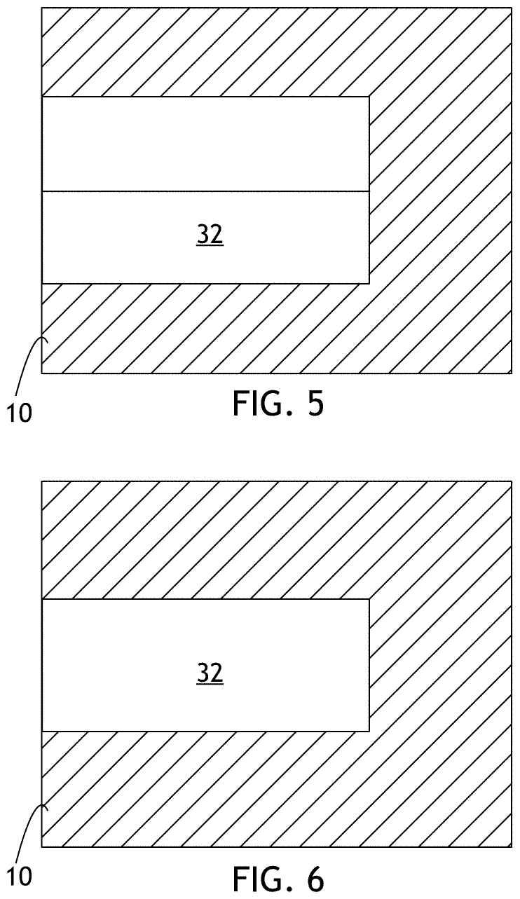

With reference to FIG. 1, a drumstick 10 has four main components: a tip 12 which is used to hit the drum, a shaft 16 serving as a handle, a tapered shoulder 14 between the tip 12 and shaft 16, and a butt 18 being the end of the drumstick 10. An axis X may be defined centrally along the length of the drumstick 10. A typical drumstick has a shaft diameter between 0.50 and 0.64 inches (1.27 and 1.63 cm) and a length between 13 to 17 inches (33.0 to 43.2 cm). A drum key presents a square negative space of about 0.21 inches (5.3 mm) for each side and so may easily fit inside the shaft of most drumsticks. One embodiment, shown in FIGS. 2-4, involves providing space in the butt and shaft of a drumstick 10 to accommodate an insert 20, with an appropriately sized and shaped negative space orifice 22. The space may be drilled or otherwise bored to an appropriate depth and the insert 20 forced into the resultant bore. Insert 20 may be secured with an adhesive, solder (in a metal shaft), or a friction fit and the orifice should be shaped in a manner to key into the shaft itself. It is preferred that the orifice 22 axially match the drumstick's axis X as this provides an elongated handle for the key function which will not interfere with its operation by interacting with the drum itself or other environmental obstacles. The insert 20 defines a negative space 22 allowing for accommodation of the head of a drum tension rod, with the current standard being 0.21 inches (5.3 mm) of length and width. The shape of the orifice may be the typical square or may also be made into other shapes as may be used in the industry in either the past or future. In a first alternate embodiment, shown in FIGS. 5 and 6, the orifice 32 may be directly fashioned into the butt of the drumstick as the negative space required to fit a drum tension rod.

The use of a sleeve designed to fit over the butt and shaft of the drumstick provides two possible alternate embodiments.

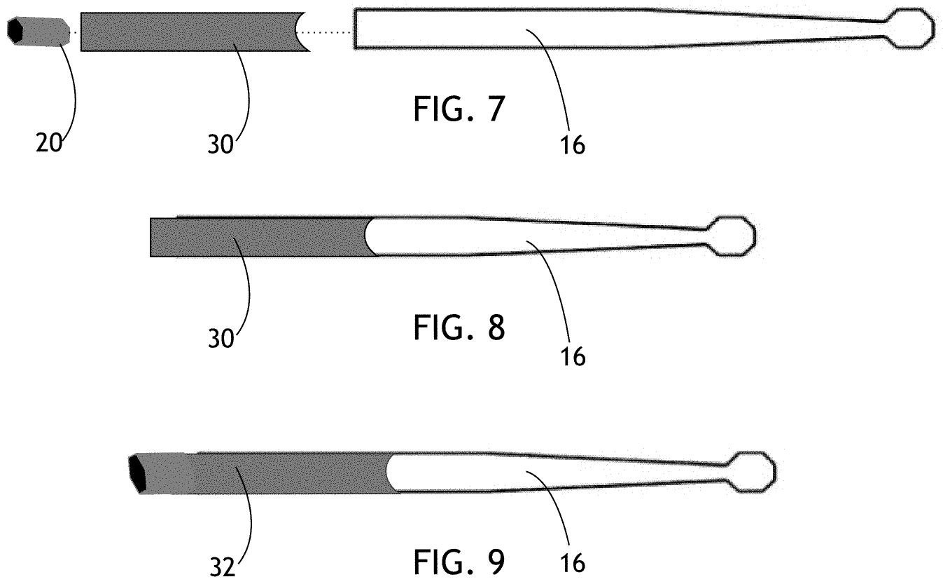

The use of a sleeve designed to fit over the butt and shaft of the drumstick provides two possible alternate embodiments, shown in FIGS. 7-9. In FIG. 7, a sleeve 30 is shown apart from either the drumstick 16 or the insert 20. These components may be fused together (FIG. 8), with the sleeve 30 providing the space necessary to contain insert 20. Alternately, the sleeve may be fashioned with an integral key portion 32 (FIG. 9). In either of these embodiments, the sleeve may be secured by use of adhesives, epoxies, a friction fit, crimping, or even screwed into the butt of the drumstick.

Although the present invention has been described with reference to preferred embodiments, numerous modifications and variations can be made and still the result will come within the scope of the invention. The described embodiments are to be considered in all respects only as illustrative and not restrictive. No limitation with respect to the specific embodiments disclosed herein is intended or should be inferred. Therefore, the scope of the invention is indicated by the appended claims rather than by the foregoing description. All changes which come within the meaning and range of equivalency of the claims are to be embraced within their scope.

What is claimed is:

1. An integrated drumstick and drum key comprising:
an elongate stick body defining a shaft with a longitudinal axis, a tip, and a butt opposite thereto; and,
a drum key fashioned in the butt of the drumstick.

2. The integrated drumstick and drum key of claim 1, the drum key being an insert that is fit into the butt and shaft of the drumstick.

3. The integrated drumstick and key of claim 2, further comprising a sleeve fit over the butt and at least part of the shaft of the drumstick, the sleeve further providing support for the insert.

4. The integrated drumstick and key of claim 1, the drum key being fashioned out of the butt and shaft of the drumstick itself.

5. The integrated drumstick and key of claim 1, further comprising a sleeve fit over the butt and at least part of the shaft of the drumstick, the drum key being integrated into the sleeve.
